(19) United States
(12) Patent Application Publication
(10) Pub. No.: US 2026/0038181 A1
(43) Pub. Date: Feb. 5, 2026

(54) INFORMATION PROCESSING DEVICE

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/076,109

(22) Filed: Mar. 11, 2025

(30) Foreign Application Priority Data
Aug. 2, 2024 (JP) 2024-127721

(51) Int. Cl. G06T 13/80; B60K 35/29; G06T 3/40

(52) U.S. Cl. CPC G06T 13/80; B60K 35/29; G06T 3/40; B60K 2360/186

(57) ABSTRACT

The information processing device includes a control unit configured to display, on a display unit, an animation such that a background image of a periphery of a vehicle image indicating the vehicle when viewed from a virtual viewpoint moves in a predetermined direction at a moving speed corresponding to a vehicle speed of the vehicle based on detection information detectable by the vehicle, and to gradually reduce a rate of a change in the moving speed that increases with an increase in the vehicle speed as the vehicle speed increases.

### CROSS-REFERENCE TO RELATED APPLICATION

This application claims priority to Japanese Patent Application No. 2024-127721 filed on Aug. 2, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Japanese Patent No. 7086798 (JP 7086798 B) discloses a technique in which an image indicating a state of the surroundings of the host vehicle is displayed on a display unit.

### SUMMARY

Here, in order to cause an occupant of the vehicle to feel a sense of speed when displaying an image indicating a state of the surroundings of the vehicle on the display unit as in the technique of JP 7086798 B, it is assumed that a background image displayed around a vehicle image indicating the vehicle is moved at a moving speed matching the vehicle speed on the display unit. However, if the moving speed of the background image continues to increase in proportion to the increase in the vehicle speed, the occupant may feel annoyed at the display content of the display unit.

Thus, an object of the present disclosure is to provide an information processing device capable of reducing the annoyance felt by an occupant of a vehicle at the display content of a display unit as compared with a case where the moving speed of a background image displayed on the display unit continues to increase in proportion to the increase in the vehicle speed.

A first aspect provides an information processing device including a control unit that causes a display unit to display an animation in which a background image around a vehicle image that indicates a vehicle as seen from a virtual viewpoint moves in a predetermined direction at a moving speed matching a vehicle speed of the vehicle based on detection information that is detectable by the vehicle, and that gradually reduces, as the vehicle speed increases, a rate of variation in the moving speed that increases along with an increase in the vehicle speed.

In the information processing device according to the first aspect, the control unit causes the display unit to display, based on the detection information, an animation in which the background image around the vehicle image as seen from the virtual viewpoint moves in a predetermined direction at a moving speed matching the vehicle speed of the vehicle. The control unit gradually reduces, as the vehicle speed increases, the rate of variation in the moving speed that increases along with the increase in the vehicle speed. Consequently, according to the information processing device, it is possible to reduce the annoyance felt by the occupant of the vehicle at the display content of the display unit as compared with a case where the moving speed of the background image displayed on the display unit continues to increase in proportion to the increase in the vehicle speed.

A second aspect provides the information processing device according to the first aspect, in which the control unit stops the variation in the moving speed when the vehicle speed has increased to a predetermined value or more.

In the information processing device according to the second aspect, the control unit stops the variation in the moving speed of the background image when the vehicle speed has increased to a predetermined value or more. Consequently, according to the information processing device, it is possible to suppress the occupant of the vehicle feeling annoyed because of the moving speed of the background image becoming too high.

A third aspect provides the information processing device according to the first or second aspect, in which the control unit reduces sharpness of the background image when the vehicle speed has increased to a predetermined value or more.

In the information processing device according to the third aspect, the control unit reduces the sharpness of the background image when the vehicle speed has increased to a predetermined value or more. Consequently, according to the information processing device, the background image is not easily seen from the occupant of the vehicle when the vehicle speed has increased to a predetermined value or more, and therefore it is possible to reduce the asthenopia of the occupant.

A fourth aspect provides the information processing device according to any one of the first to third aspects, in which the control unit varies a display size of a landscape image regardless of variation in the vehicle speed when displaying the landscape image on the display unit, the display size of the landscape image being varied according to a positional relationship with the vehicle.

In the information processing device according to the fourth aspect, the control unit varies the display size of the landscape image regardless of variation in the vehicle speed when the landscape image is displayed on the display unit. Consequently, according to the information processing device, it is possible to reduce the annoyance felt by the occupant of the vehicle at the landscape image as compared with a case where the display size of the landscape image continuously varies in correspondence with variation in the vehicle speed.

A fifth aspect provides the information processing device according to any one of the first to fourth aspects, in which the control unit moves the background image to a side opposite to a traveling direction of the vehicle during acceleration of the vehicle, and moves the background image to a side in the traveling direction of the vehicle during deceleration of the vehicle.

In the information processing device according to the fifth aspect, the control unit moves the background image to the side opposite to the traveling direction of the vehicle when the vehicle is accelerating, and moves the background image to the side in the traveling direction of the vehicle when the vehicle is decelerating. Consequently, according to the information processing device, it is possible to express that the vehicle is traveling by moving the background image, and it is possible to make the occupant of the vehicle feel acceleration and deceleration based on the moving direction of the background image.

As described above, in the information processing device according to the present disclosure, it is possible to reduce the annoyance felt by the occupant of the vehicle at the display content of the display unit as compared with a case where the moving speed of the background image displayed on the display unit continues to increase in proportion to the increase in the vehicle speed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a flowchart illustrating a flow of a specific process;

FIG. 3 is a graph showing a relationship between a vehicle speed and a change in a moving speed of a background image;

FIG. 4 is a first display example displayed on a monitor;

FIG. 5 is a second exemplary display displayed on a monitor; and

FIG. 6 is a third display example displayed on the monitor.

### DETAILED DESCRIPTION OF EMBODIMENTS

Hereinafter, the vehicle 10 according to the present embodiment will be described.

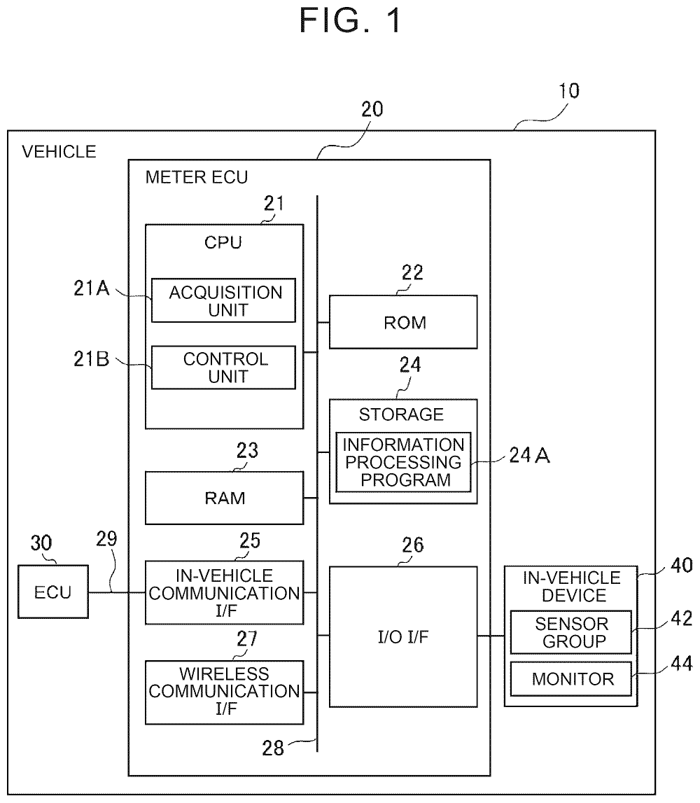

FIG. 1 is a block diagram illustrating a hardware configuration of a vehicle 10. As illustrated in FIG. 1, the vehicles 10 include a meter ECU (Electronic Control Unit) 20. The vehicle 10 is an example of a “vehicle” of the present disclosure, and the meter ECU 20 is an example of an “information processing device” of the present disclosure.

The meter ECU 20 includes CPU (Central Processing Unit) 21, ROM (Read Only Memory) 22, RAM (Random Access Memory) 23, storage 24, in-vehicle communication I/F (interface) 25, input/output I/F 26, and wireless communication I/F 27. CPU 21, ROM 22, RAM 23, the storage 24, the in-vehicle communication I/F 25, the input/output I/F 26, and the wireless communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

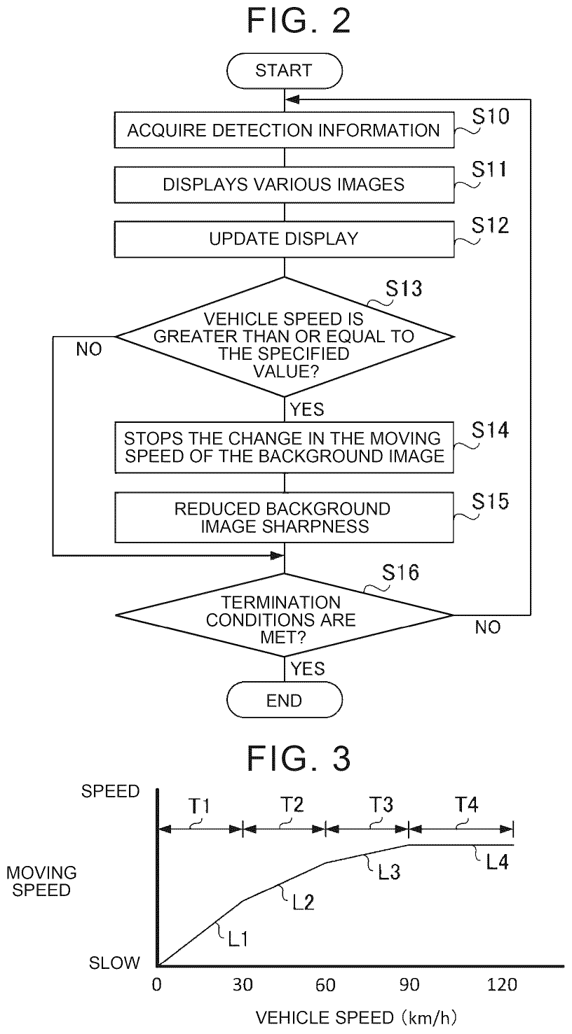

The storage 24 is constituted by a storage device such as an eMMC (embedded Multi Media Card) or a UFS (Universal Flash Storage), and stores various programs and various data. The storage 24 stores information processing program 24A. The information processing program 24A is a program for causing CPU 21 to execute a specifying process (see FIG. 2), which will be described later.

The in-vehicle communication I/F 25 is an interface for connecting to another ECU 30. The interface uses a CAN protocol-based communication standard. The in-vehicle communication I/F 25 is connected to an external bus 29. Although not shown, a plurality of ECU is provided for each function of the vehicles 10 in addition to ECU 30.

The input/output I/F 26 is an interface for communicating with the in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes, for example, a 3D-LiDAR, a millimeter-wave sensor, an infra-red sensor, a winker sensor, an accelerator position sensor, a vehicle speed sensor, a steering angle sensor, an angular velocity sensor, a GPS (Global Positioning System) sensor, an illuminance sensor, a gyroscope, a sensor for detecting a state of the vehicle 10 and a state around the vehicle 10, a plurality of cameras for imaging the periphery of the vehicle 10, and the like. The sensor group 42 outputs a detection result of each sensor and an image captured by each camera to the meter ECU 20, ECU 30, and the like.

The monitor 44 is a meter display provided on a meter panel disposed in front of the driver's seat of the vehicle 10 and for displaying an operation proposal related to the function of the vehicle 10, an image related to the explanation of the function, and the like. The monitor 44 is an example of a “display unit” of the present disclosure.

The wireless communication I/F 27 is a wireless communication module for communicating with an external device. As the wireless communication module, for example, communication standards such as 5G, LTE, Wi-Fi (registered trademark) and Bluetooth (registered trademark) are used.

Further, CPU 21 of the meter ECU 20 has, as a functional configuration, an acquiring unit 21A and a control unit 21B. The respective functional configurations are realized by CPU 21 reading and executing the information processing program 24A stored in the storage 24. The control unit 21B is an exemplary “control unit” of the present disclosure.

The acquiring unit 21A acquires various types of data. For example, the acquiring unit 21A acquires detection information that can be detected by the vehicles 10 as various types of information. The detection information includes a detection result by each sensor constituting the sensor group 42, a captured image by each camera, and the like.

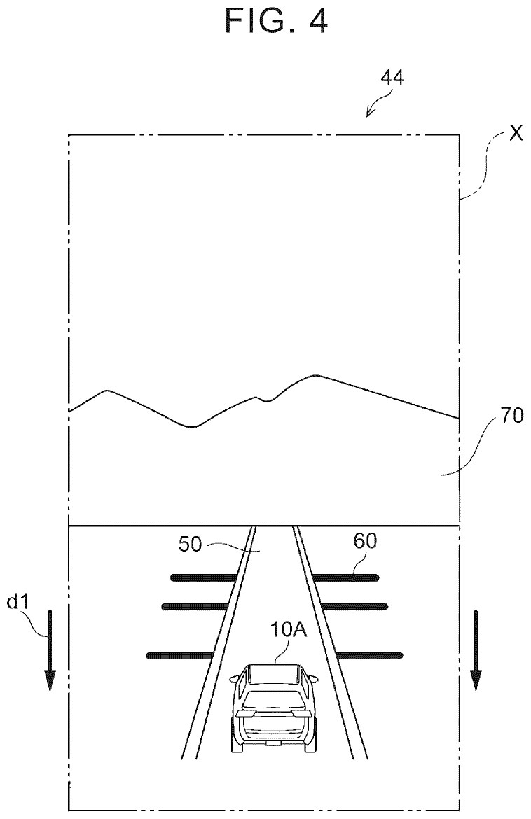

The control unit 21B performs display control related to the display of the monitor 44. For example, the control unit 21B causes the monitor 44 to display, as the display control, vehicle image 10A (see FIG. 4 and the like) indicating the vehicle 10 when viewed from the virtual viewpoint, based on the detection information acquired by the acquiring unit 21A. The virtual viewpoint is set on a three-dimensional virtual space whose origin is the position of the vehicle-image 10A, and is defined by viewpoint coordinates and viewpoint angles (orientations) on the virtual space. For example, the virtual viewpoint is a viewpoint viewed at a specific viewpoint angle from a specific viewpoint coordinate on the upper side of the vehicle-image 10A in the virtual space.

In addition, the control unit 21B causes the monitor 44 to display, as the display control, an animation in which the background image 60 (see FIG. 4 and the like) around the vehicle image 10A moves at a moving speed corresponding to the vehicle speed of the vehicle 10 based on the detection information acquired by the acquiring unit 21A. The moving speed of the background image 60 increases with an increase in the vehicle speed.

FIG. 2 is a flow chart illustrating a flow of a specifying process executed by the meter ECU 20. CPU 21 reads the information processing program 24A from the storage 24, develops it in RAM 23, and executes it, thereby performing the specifying process. As an example, the identification processing is performed repeatedly and automatically every time a certain period of time elapses.

In S10 illustrated in FIG. 2, CPU 21 acquires detection data detectable by the vehicles 10. Then, CPU 21 proceeds to S11.

In S11, CPU 21 displays various images on the monitor 44 based on the detection data acquired by S10. The various images are a vehicle image 10A, a road image 50 (see FIG. 4 and the like) indicating a road on which the vehicle 10 travels, a background image 60, and the like. Specific examples of the various images will be described later. Then, CPU 21 proceeds to S12.

In S12, CPU 21 updates the content displayed on the monitor 44 based on the detection data acquired by S10. For example, when the vehicle speed of the vehicle 10 increases, CPU 21 increases the moving speed of the background image 60 displayed on the monitor 44, or when the vehicle 10 approaches the other vehicle, 10A of the vehicle image on the monitor 44 and the image indicating the other vehicle are narrowed. Then, CPU 21 proceeds to S13.

In S13, CPU 21 determines whether or not the vehicle speed of the vehicle 10 is equal to or higher than a predetermined value, for example, a 90 km/h. Here, CPU 21 proceeds to S14 when it is determined that the vehicle speed is equal to or higher than 90 km/h value (S13: YES). On the other hand, when it is determined that the vehicle speed is not equal to or higher than 90 km/h value (S13: NO), CPU 21 proceeds to S16. As an example, CPU 21 determines whether or not the vehicle speed is equal to or higher than a 90 km/h value as a predetermined value, based on the detection result of the vehicle speed sensor included in the sensor group 42.

In S14, CPU 21 halts the change in velocity of motion of the background images 60. That is, when the vehicle speed is equal to or higher than 90 km/h, CPU 21 makes the moving speed of the background images 60 constant without depending on the increase in the vehicle speed. Then, CPU 21 proceeds to S15.

In S15, CPU 21 reduces the sharpness of the background images 60 as compared to when the vehicle speed is less than 90 km/h. That is, when the vehicle speed is equal to or higher than 90 km/h value, CPU 21 reduces the ease of checking when the driver who is the occupant of the vehicle 10 visually views the background images 60. Then, CPU 21 proceeds to S16.

In S16, CPU 21 determines whether a predetermined termination condition is satisfied. Here, when CPU 21 determines that the termination condition is satisfied (S16: YES), the specifying process is terminated. On the other hand, when it is determined that the termination condition is not satisfied (S16: NO), CPU 21 returns to S10. As an example, CPU 21 determines that the termination condition is satisfied when the ignition switch of the vehicle 10 is turned off.

Next, the relationship between the vehicle speed and the change in the moving speed of the background image 60 will be described with reference to FIG. 3. FIG. 3 is a graph showing the relationship between the vehicle speed and the change in the moving speed of the background image 60. In the graph, the vertical axis indicates the moving speed of the background image 60, and the horizontal axis indicates the vehicle speed.

During the period T1 in which the vehicle speed is equal to or higher than 0 km/h and lower than 30 km/h, the moving speed is accelerated by the inclination indicated by the line segment L1 as the vehicle speed increases.

During the period T2 in which the vehicle speed is equal to or higher than 30 km/h and lower than 60 km/h, the moving speed is accelerated by the inclination indicated by the line segment L2 as the vehicle speed increases. Here, the slope indicated by the line segment L2 is gentler than the slope indicated by the line segment L1.

During the period T3 in which the vehicle speed is equal to or higher than 60 km/h and lower than 90 km/h, the moving speed is accelerated by the inclination indicated by the line segment L3 as the vehicle speed increases. Here, the slope indicated by the line segment L3 is gentler than the slope indicated by the line segment L2.

As described above, during the period T1, the period T2, and the period T3 in which the vehicle speed is equal to or higher than 0 km/h and lower than 90 km/h, the moving speed increases with the increase in the vehicle speed. On the other hand, the rate of change in the moving speed indicated by the inclination of the graph gradually decreases as the vehicle speed increases.

During the period T4 in which the vehicle speed is equal to or greater than 90 km/h value, which is an exemplary predetermined value, the inclination becomes 0 as shown in the line segment L4. As described above, when the vehicle speed is increased to 90 km/h or higher, the change in the moving speed of the background images 60 is stopped. During the period T4, the background images 60 move at the upper limit speed which is the upper limit of the moving speed.

Next, a display example of the monitor 44 will be described with reference to FIGS. 4 to 6.

FIG. 4 is a first display example displayed in the display area X of the monitor 44. The display area X is a partial area of the monitor 44, and is visible through an opening of the steering wheel by a driver seated in the driver's seat. As an example, FIG. 4 shows display contents at the time of acceleration of the vehicle 10.

In the lower portion of the display area X shown in FIG. 4, the vehicle image 10A is displayed on the road image 50 so as to be directed upward in the drawing showing the traveling direction-side of the vehicle 10. The road image 50 is an image showing a road around the vehicle 10 shown in the map data stored in the external server, the storage 24, or the like.

The vehicle image 10A is an image generated based on the illustration design of the vehicle 10 shown in the illustration data stored in the storage 24. As an example, the vehicle 10 travels on a straight road. Therefore, in FIG. 4, the vehicle image 10A is displayed in the straight road shown in the road image 50 from the viewpoint viewed from the virtual viewpoint. The vehicle image 10A is an exemplary “vehicle image” of the present disclosure.

In addition, a background image 60 indicated by six streamlines extending to the left and right of the road image 50 is displayed around the vehicle image 10A. Here, when the vehicle 10 accelerates, the six streamlines move in the direction opposite to the traveling direction of the vehicle 10, specifically, downward in the drawing indicated by the arrow d1. Then, the streamline that has moved to the predetermined lower end position once disappears from the monitor 44, appears from the predetermined upper end position, and moves downward in the drawing again. As described above, when the vehicle 10 is accelerated, an animation in which the background image 60 moves downward in the drawing is displayed on the monitor 44. The background image 60 is an example of a “background image” of the present disclosure, and the lower part of the drawing indicated by an arrow d1 is an example of a “predetermined orientation” of the present disclosure.

As described above, during the period T1, the period T2, and the period T3 (refer to FIG. 3) in which the vehicle speed is equal to or higher than 0 km/h and lower than 90 km/h, the moving speed of the background images 60 toward the lower side in the drawing increases with the increase in the vehicle speed.

Further, in the display area X shown in FIG. 4, a landscape image 70 indicating a landscape around the vehicle 10 is displayed in an upper portion of the road image 50. The landscape image 70 is an image showing the landscape around the vehicle 10 identified from the map data. The landscape image 70 is an example of a “landscape image” of the present disclosure.

As an example, the landscape image 70 is an illustration image simulating the mountain A existing around the vehicle 10 as a landscape of a predetermined mountain road. The illustration data of the mountain A is stored in the storage 24, for example. CPU 21 acquires the illustration data of the mountain A from the storage 24 based on the fact that the traveling location of the vehicle 10 has changed to the mountain road, and draws the illustration data as the landscape image 70. It is to be noted that, among the roads shown in the map data, which part corresponds to the mountain road is determined in advance, and CPU 21 determines whether or not the traveling location of the vehicle 10 has changed to the mountain road based on the detection information and the map data.

Here, the display size of the landscape image 70 changes according to the positional relationship with the vehicle 10. As an example, in the present embodiment, as the display size of the landscape image 70, a small size, a medium size larger than the small size, and a large size larger than the medium size are provided.

As an example, CPU 21 displays the landscape images 70 in a small size when the distance between the vehicles 10 and the mountain A is equal to or greater than the first distance. Further, CPU 21 displays the landscape images 70 in a medium size when the distance between the vehicles 10 and the mountain A is less than the first distance and is equal to or greater than the second distance that is shorter than the first distance. Then, when the distance between the vehicles 10 and the mountain A is less than the second distance, CPU 21 displays the landscape images 70 in a large size. As described above, the landscape image 70 differs from the background image 60 in which the moving speed changes in accordance with the change in the vehicle speed, and the display size changes in accordance with the distance between the vehicle 10 and the mountain A regardless of the change in the vehicle speed. As an example, the display size of the landscape image 70 illustrated in FIG. 4 is a medium size.

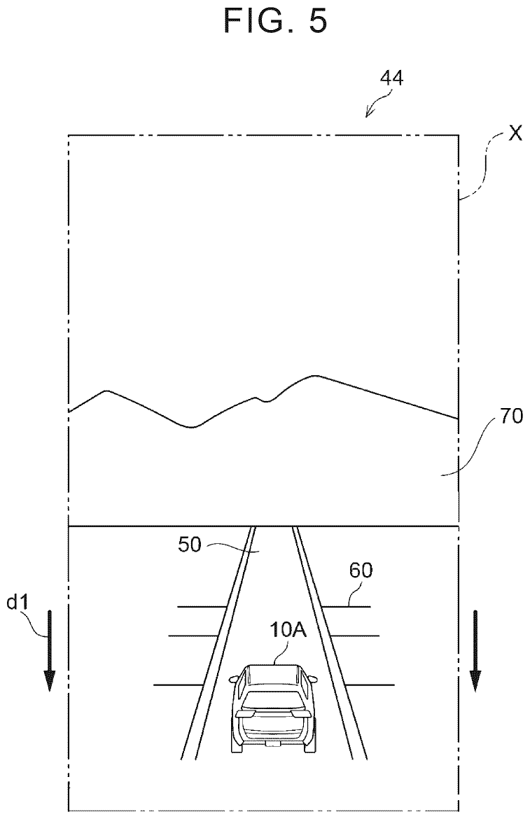

FIG. 5 is a second display example displayed in the display area X of the monitor 44. As an example, FIG. 5 shows a display content when the vehicle speed is increased to a 90 km/h or higher. FIG. 5 shows a case where the vehicles 10 are accelerated from the state shown in FIG. 4, and six streamlines shown as background images 60 are moved downward in the figure shown by an arrow d1 from FIG. 4.

As described above, CPU 21 stops the change in the moving speed of the background images 60 when the vehicle speed increases to 90 km/h or higher. Therefore, in the condition shown in FIG. 5, the background images 60 move downward in the drawing indicated by the arrow d1 at a constant upper limit speed without depending on the increase in the vehicle speed.

In addition, as described above, CPU 21 reduces the sharpness of the background images 60 when the vehicle speed increases to a 90 km/h or higher. In the present embodiment, the sharpness of the background image 60 is reduced by reducing the thicknesses of the six streamlines shown as the background image 60. Therefore, in the background image 60 shown in FIG. 5, the thicknesses of the six streamlines are thinner than those of the background image 60 shown in FIG. 4.

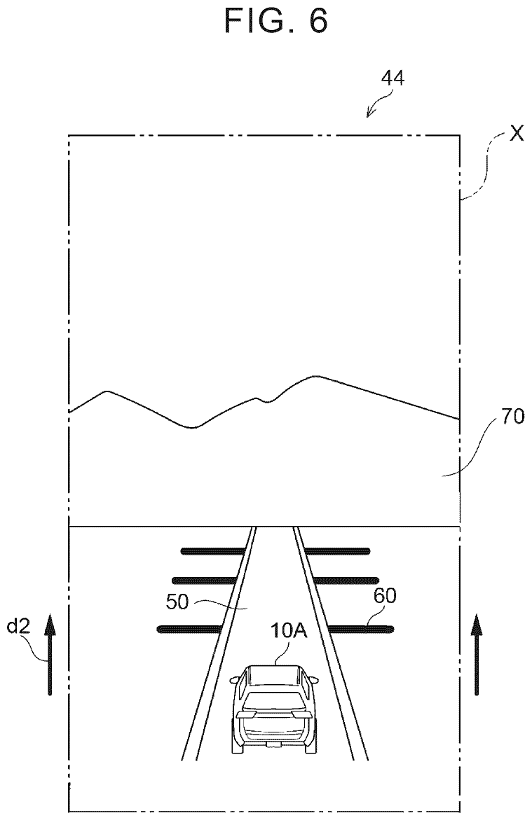

FIG. 6 is a third display example displayed in the display area X of the monitor 44. As an example, FIG. 6 shows the display contents at the time of deceleration of the vehicle 10. FIG. 6 shows a case where the vehicle 10 decelerates from the state shown in FIG. 4, and six streamlines shown as the background images 60 are moved upward in the drawing indicated by an arrow d2 than in FIG. 4.

In the display area X shown in FIG. 6, a vehicle image 10A, a road image 50, a background image 60, and a landscape image 70 are displayed. Note that the above-described display modes of the respective images are the same as those in FIG. 4, and thus the description thereof will be omitted or simplified.

The background image 60 is shown with six streamlines extending to the left and right of the road image 50 as in FIGS. 4 and 5. Here, when the vehicle 10 decelerates, the six streamlines move upward in the drawing indicated by the arrow d2, specifically, toward the traveling direction of the vehicle 10. Then, the streamline that has moved to the predetermined upper end position once disappears from the monitor 44, appears from the predetermined lower end position, and moves upward in the drawing again. As described above, when the vehicle 10 decelerates, an animation in which the background image 60 moves upward in the drawing is displayed on the monitor 44.

As described above, in the meter ECU 20, CPU 21 causes the monitor 44 to display an animation based on the detection information as a function of the control unit 21B. In the animation, the background image 60 around the vehicle image 10A when viewed from the virtual viewpoint moves downward (opposite to the traveling direction of the vehicle 10) in the drawing indicated by the arrow d1 in FIGS. 4 and 6 at a moving velocity corresponding to the vehicle speed of the vehicle 10. Then, CPU 21, as a function of the control unit 21B, gradually decreases the rate of change in the moving speed that increases with the increase in the vehicle speed as the vehicle speed increases. Accordingly, according to the meter ECU 20, it is possible to reduce the troublesomeness that the driver feels with respect to the displayed content of the monitor 44 as compared with a case where the moving speed of the background images 60 displayed on the monitor 44 continues to increase in proportion to the increase in the vehicle speed.

Further, in the meter ECU 20, as a function of the control unit 21B, CPU 21 stops the change in the moving speed of the background images 60 when the vehicle speed increases to a 90 km/h or more, which is an exemplary predetermined value. Accordingly, according to the meter ECU 20, it is possible to prevent the driver from feeling complicated because the moving velocity of the background images 60 becomes too high.

Further, in the meter ECU 20, as a function of the control unit 21B, CPU 21 reduces the sharpness of the background images 60 when the vehicle speed rises to a 90 km/h or higher. Thus, according to the meter ECU 20, the background images 60 are less visible from the driver when the vehicle speed rises to a 90 km/h or higher, and thus the eyestrain of the driver can be reduced.

In the meter ECU 20, CPU 21 changes the display size of the landscape image 70 regardless of the change in the vehicle speed when the landscape image 70 is displayed on the monitor 44 as a function of the control unit 21B. Accordingly, according to the meter ECU 20, it is possible to reduce the troublesomeness felt by the driver with respect to the landscape image 70 as compared with a case where the display-size of the landscape image 70 continuously changes in response to a change in the vehicle speed.

Further, in the meter ECU 20, as a function of the control unit 21B, CPU 21 moves the background image 60 to the side opposite to the traveling direction of the vehicle 10 when the vehicle 10 is accelerated, and moves the background image to the traveling direction side of the vehicle 10 when the vehicle 10 is decelerated. Accordingly, according to the meter ECU 20, it is possible to express that the vehicle 10 is traveling by moving the background image 60, and it is possible to cause the driver to feel an acceleration feeling and a deceleration feeling based on the moving direction of the background image 60.

### Others

Although the embodiments of the present disclosure have been described in detail with reference to the accompanying drawings, the technical scope of the present disclosure is not limited to such examples. It will be apparent to those skilled in the art that various modifications and variations can be made within the scope of the technical idea described in the claims. It is to be understood that these variations or modifications are of course within the scope of the present disclosure.

Further, the effects described in the above embodiments are illustrative or exemplary, and are not limited to those described in the above embodiments. That is, the technology according to the present disclosure can produce other effects that are obvious to a person having ordinary knowledge in the technical field of the present disclosure from the description in the above embodiment, together with the effects described in the above embodiment or instead of the effects described in the above embodiment.

The processing described in the above embodiment can also be realized by a dedicated hardware circuit. In this case, it may be executed by one piece of hardware or by a plurality of pieces of hardware.

In the above-described embodiment, the information processing program 24A is stored in the storage 24. However, the present disclosure is not limited thereto, and the information processing program 24A may be stored in ROM 22.

In the above-described embodiment, the background image 60 is represented by a streamline, but the display content of the background image 60 is not limited thereto. For example, the background image 60 may be an image indicating a target, such as a pole, a street tree, or a building, identified based on the detection information.

In the above-described embodiment, the landscape image 70 is an image imitating a mountain for showing a landscape of a predetermined mountain road, but the display content of the landscape image 70 is not limited thereto. For example, the landscape image 70 may be an image that mimics the sea to indicate a landscape at a predetermined beach, an image that mimics a building to indicate a landscape in a predetermined urban area, or the like.

In the above-described embodiment, the sharpness of the background image 60 is reduced by reducing the thicknesses of the six streamlines shown as the background image 60, but the method of reducing the sharpness is not limited thereto. For example, the number of streamlines may be reduced from six to four or the like, or the color of the streamlines may be reduced to reduce the sharpness of the background image 60.

In the above-described embodiment, when the vehicle speed increases to a predetermined value or more, the change in the moving speed of the background image 60 is stopped, but the present disclosure is not limited thereto. For example, depending on the state of the vehicle 10, the traveling place of the vehicle 10, and the like, even when the vehicle speed increases to a predetermined value or more, the moving speed of the background image 60 may be increased with the increase in the vehicle speed without stopping the change in the moving speed of the background image 60. Specifically, when the state of the vehicle 10 is an automated driving mode in which ECU 30 performs some or all of the driving operations of the vehicle 10, such as acceleration, braking, and steering, regardless of the driver, CPU 21 may increase the moving speed of the background images 60 as the vehicle speed increases even after the vehicle speed increases to a predetermined value or more. In addition, when the traveling place of the vehicle 10 is located at a specific place where motor sports such as a courses of a circuit place and a rally can be performed in which the sport traveling by pulling up the vehicle speed at which the speed limiter of the vehicle 10 operates is performed, CPU 21 may increase the moving speed of the background images 60 as the vehicle speed increases even after the vehicle speed increases to a predetermined value or more.

In the above-described embodiment, CPU 21 may differ in the manner in which the background images 60 are displayed at the time of acceleration and deceleration of the vehicles 10. In other words, CPU 21, when moving the background image 60 to the opposite side of the traveling direction of the vehicle 10, the display mode of the background image 60 in the case of moving to the traveling direction of the vehicle 10 may be different. For example, CPU 21 may vary the color of the six streamlines shown as background images 60 during acceleration and deceleration of vehicles 10.

In the above embodiment, the monitor 44, which is a meter display, is an example of the “display unit” of the present disclosure, but the example of the “display unit” is not limited to the meter display. For example, an exemplary “display unit” may be other displays, such as a center display and a head-up display (HUD). An example of the “display unit” may be a combination of a plurality of displays such as a meter display and a center display.

In the above-described embodiment, the meter ECU 20 executes the specifying process illustrated in FIG. 2. However, the present disclosure is not limited thereto, and the specifying process may be executed by the meter ECU 20 and other ECU in cooperation with each other.

It should be noted that the identifying process executed by CPU 21 reading the software (program) in the above-described embodiment may be executed by various processors other than CPU. Examples of the processor include a PLD (Programmable Logic Device) in which a circuit configuration can be changed after manufacturing of FPGA (Field-Programmable Gate Array), and the like, and a dedicated electric circuit that is a processor having a circuit configuration designed exclusively for executing a particular process such as ASIC (Application Specific Integrated Circuit), and the like. Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above-described embodiment, the information processing program 24A is stored (installed) in the storage 24 in advance, but the present disclosure is not limited thereto. The information processing program 24A may be provided in a form recorded in a recording medium such as CD-ROM (Compact Disk Read Only Memory), DVD-ROM (Digital Versatile Disk Read Only Memory), and USB (Universal Serial Bus). Further, the information processing program 24A may be downloaded from an external device via a network. Note that the technology of the present disclosure can also be applied to programs and program products.

What is claimed is:

1. An information processing device comprising a control unit that causes a display unit to display an animation in which a background image around a vehicle image that indicates a vehicle as seen from a virtual viewpoint moves in a predetermined direction at a moving speed matching a vehicle speed of the vehicle based on detection information that is detectable by the vehicle, and that gradually reduces, as the vehicle speed increases, a rate of variation in the moving speed that increases along with an increase in the vehicle speed.

2. The information processing device according to claim 1, wherein the control unit stops the variation in the moving speed when the vehicle speed has increased to a predetermined value or more.

3. The information processing device according to claim 1, wherein the control unit reduces sharpness of the background image when the vehicle speed has increased to a predetermined value or more.

4. The information processing device according to claim 1, wherein the control unit varies a display size of a landscape image regardless of variation in the vehicle speed when displaying the landscape image on the display unit, the display size of the landscape image being varied according to a positional relationship with the vehicle.

5. The information processing device according to claim 1, wherein the control unit moves the background image to a side opposite to a traveling direction of the vehicle during acceleration of the vehicle, and moves the background image to a side in the traveling direction of the vehicle during deceleration of the vehicle.
